(19) United States
(12) Patent Application Publication
(10) Pub. No.: US 2026/0240081 A1
(43) Pub. Date: Aug. 20, 2026

(54) BALERS AND METHODS OF MANAGING BELT SLACK IN SAME

(71) Applicant: Vermeer Manufacturing Company, Pella, IA (US)

(72) Inventors: Luke A. Mushitz, Mitchell, SD (US); Adam Barkema, Pella, IA (US); Calvin D. Meinders, Pella, IA (US); Kent M. Recker, Pella, IA (US)

(21) Appl. No.: 19/535,978

(22) Filed: Feb. 10, 2026

Related U.S. Application Data
(60) Provisional application No. 63/760,333, filed on Feb. 19, 2025.

(51) Int. Cl. A01F 15/07; A01F 15/08

(52) U.S. Cl. CPC A01F 15/07; A01F 15/0715; A01F 15/0833; A01F 2015/077; A01F 2015/0795

(57) ABSTRACT

Round balers are disclosed. The round baler may include a front frame portion and a tailgate pivotally coupled to the front frame portion. A drive system is disposed within the front frame portion. A drive roller is coupled to the drive system. The drive system is configured to drive the drive roller. A belt tightener is rotatably coupled to the front frame portion. The belt tightener includes a belt tightener roller. The round baler includes a plurality of belts for forming a bale chamber. A plurality of rollers contact the plurality of belts. The plurality of rollers include the drive roller, the belt tightener roller, and a plurality of idler rollers. A biasing assembly is coupled to the front frame portion. The biasing assembly is configured to contact the plurality of belts and press the plurality of belts against one of the plurality of rollers.

### CROSS-REFERENCE TO RELATED APPLICATIONS

This application claims the benefit of U.S. Provisional Patent Application No. 63/760,333, filed Feb. 19, 2025, which is incorporated herein in its entirety.

### DISCUSSION OF ART

The field of the disclosure relates to balers for baling crop and forage material and, in particular, to balers including various components for managing belt slack and methods for managing belt slack.

During operation of a baler, belts are continuously driven by drive rollers. The belts are driven continuously during operation—more specifically, when the baler is empty (e.g., no crop in the chamber), during bale formation, during bale wrapping/tying, and during bale ejection. Upon release or ejection of the bale, the process repeats with an empty baler when a tailgate of the baler closes. The drive rollers of the baler rotate continuously through the baling process, i.e., the operator and/or controller does not stop powering the belt drive system. However, belt tension may vary during the baling process. Generally, the belts are tight anytime the tailgate of the baler is closed (e.g., empty bale chamber, during bale formation, during wrapping/tying). There is a period of time during bale ejection where the belt tension is removed due to the configuration of the baler. For example, during bale ejection, when the tailgate is opened the belt path is shortened, a belt tightener of the baler is prevented from tensioning the belts until the bale is partially ejected. Until the bale is partially ejected, the belt tension is considerably lower or zero, causing reduced drive friction between the belts and the belt drive rollers. The lowered or zero tension results in belt movement typically stopping until the bale ejects far enough for the belt tightener to reengage and apply tension to the belts. During the time of low or zero belt tension, the loose belts have slack that may create a droop in the belts. As the bale is ejected, the belt tightener begins to move and retention the belts, causing the belts to move again, thereby moving the belt slack. During the period of belt slack, the loose belts may move or shift to undesirable locations, such as the gap between the start roller and the lower drive roller. This droop or slack can cause damage to the belt or other baler components. The loose belts may also cause damage to the bale, particularly scuffing or creating holes in the wrap on the outside of the bale.

### SUMMARY

One aspect of the present disclosure is directed to a round baler. The round baler includes a front frame portion and a tailgate pivotally coupled to the front frame portion. A drive system is disposed within the front frame portion. A drive roller is coupled to the drive system. The drive system is configured to drive the drive roller. A belt tightener is rotatably coupled to the front frame portion. The belt tightener includes a belt tightener roller. The round baler includes a plurality of belts for forming a bale chamber. A plurality of rollers contact the plurality of belts. The plurality of rollers include the drive roller, the belt tightener roller, and a plurality of idler rollers. A biasing assembly is coupled to the front frame portion. The biasing assembly is configured to contact the plurality of belts and press the plurality of belts against one of the plurality of rollers.

Another aspect of the present disclosure is directed to a method of controlling belt slack in a round baler during bale discharge. The round baler includes a front frame portion, a tailgate pivotally coupled to the front frame portion, a drive roller, a belt tightener including a belt tightener roller, a plurality of belts for forming a bale chamber, and a plurality of rollers that contact the plurality of belts. The plurality of rollers include the drive roller, the belt tightener roller, and a plurality of idler rollers. The round baler includes a biasing assembly coupled to the front frame portion. A bale is formed in the bale chamber of the round baler. The tailgate is raised and the bale is discharged from the round baler. The drive roller is driven during bale formation and bale discharge. The biasing assembly contacts the plurality of belts and presses the plurality of belts against one of the plurality of rollers while the tailgate is raised.

### BRIEF DESCRIPTION OF THE DRAWINGS

FIG. 1 is a rear perspective view of a baler including a push arm assembly for controlling belt slack;

FIG. 2 is a front perspective view of the baler of FIG. 1;

FIG. 3 is a perspective, cross-sectional view of the baler taken along line 3-3 of FIG. 2;

FIG. 4 is a schematic view of a portion of the components of the baler of FIG. 1;

FIG. 5 is a perspective view of the push arm assembly included in a baler;

FIG. 6 is an enlarged view of a portion of the push arm assembly of FIG. 5;

FIG. 7 is an exploded view of an arm sub-assembly of the push arm assembly of FIG. 5;

FIG. 8 is an enlarged, perspective view of a portion of the baler including the push arm assembly of FIG. 5;

FIG. 9 is a side cross-sectional view of a portion of the baler;

FIGS. 10-13 are schematic views of the baler undergoing processes for forming a bale therein;

FIG. 14A is a side cross-sectional view of the baler prior to ejecting the bale from the baling chamber;

FIG. 14B is a side cross-sectional view of the baler after ejecting the bale from the baling chamber;

FIG. 14C is a side cross-sectional view of a portion of the baler after ejecting the bale from the baling chamber;

FIGS. 15-19 are perspective views of additional embodiments of a push arm assembly;

FIGS. 20 and 21 are side cross-sectional views of a portion of a baler including additional embodiments of the push arm assembly;

FIG. 22 is a side cross-sectional view of a portion of a baler including a belt brake assembly;

FIG. 23 is a rear perspective view of a baler including the belt brake assembly and a lifted tailgate;

FIG. 24 is a cross-sectional view of the baler taken along line 24-24 in FIG. 23;

FIG. 25 is an enlarged, cross-sectional view of the baler in FIG. 24; and

FIG. 26 is a rear perspective view of a baler including a drive system having at least one controllable clutch.

### DETAILED DESCRIPTION

Exemplary embodiments discussed herein relate to balers that include various components and assemblies that facilitate the control of belt slack within the baler during instances of no or low tension on the belts (e.g., after bales are ejected from the baler).

Balers discussed herein utilize various components and/or assemblies for controlling the belt slack during operation of the baler. For example, a push arm assembly can be included within the baler to apply a force to the belt such that contact is maintained between the belt and drive roller and ultimately ensuring a desired amount of friction is maintained between the belt and a drive roller within the baler. Additionally, or alternatively, balers described herein can include a belt brake assembly that can pinch the belts between the brake arm and a component of the baler (e.g., belt roller, cross member, and the like) within a desired area of the baler. Moreover, a drive system of the baler can include at least one clutch to selectively engage the drive rollers during operation of the baler to control the belt slack. Controlling the belt slack using one or more of the components or assemblies discussed herein ensures the location where belt slack occurs during operation of the baler is maintained and/or generated within a predetermined, desired area of the baler during operation.

When introducing elements of various embodiments disclosed herein, the articles “a”, “an”, “the”, and “said” are intended to mean that there are one or more of the elements. The terms “comprising”, “including”, and “having” are intended to be inclusive and mean that there may be additional elements other than the listed elements.

Unless otherwise indicated, approximating language, such as “generally”, “substantially”, and “about”, as used herein indicates that the term so modified may apply to only an approximate degree, as would be recognized by one of ordinary skill in the art, rather than to an absolute or perfect degree. Accordingly, a value modified by a term or terms such as “about”, “approximately”, and “substantially” is not to be limited to the precise value specified. In at least some instances, the approximating language may correspond to the precision of an instrument for measuring the value. Additionally, unless otherwise indicated, the terms “first”, “second”, etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

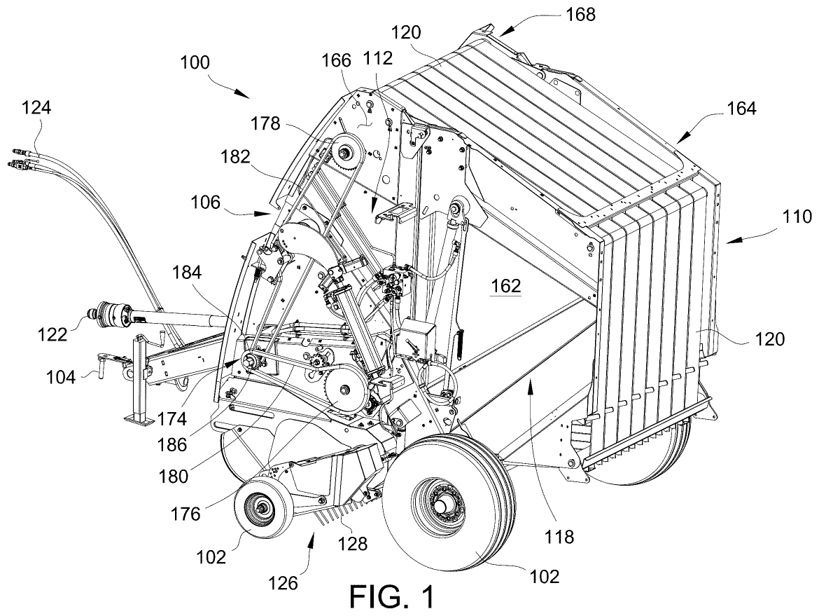

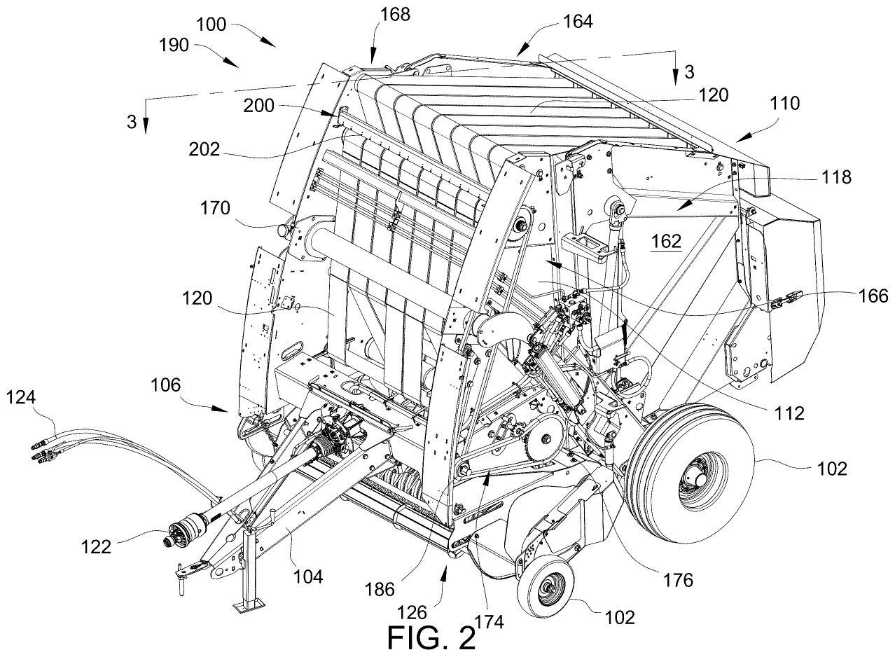

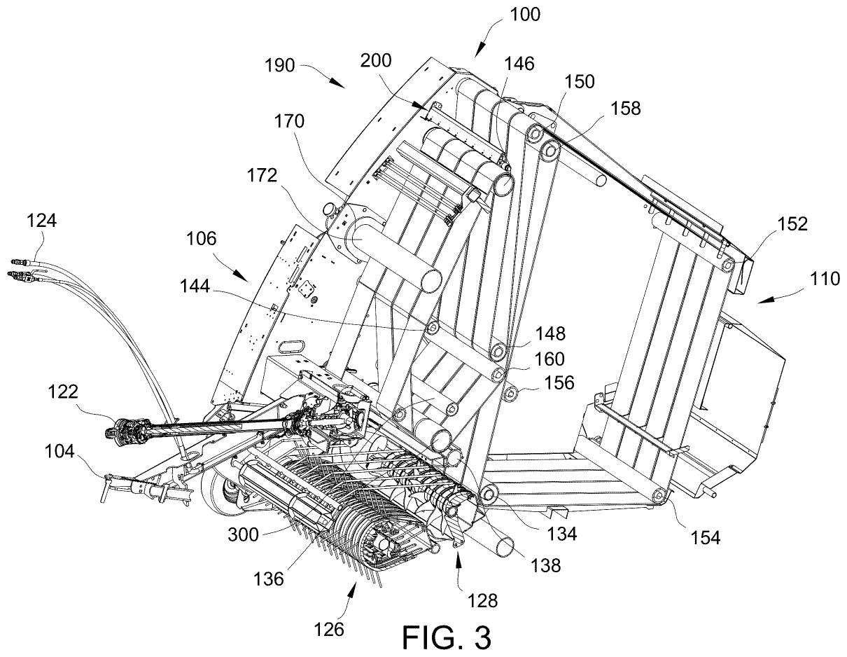

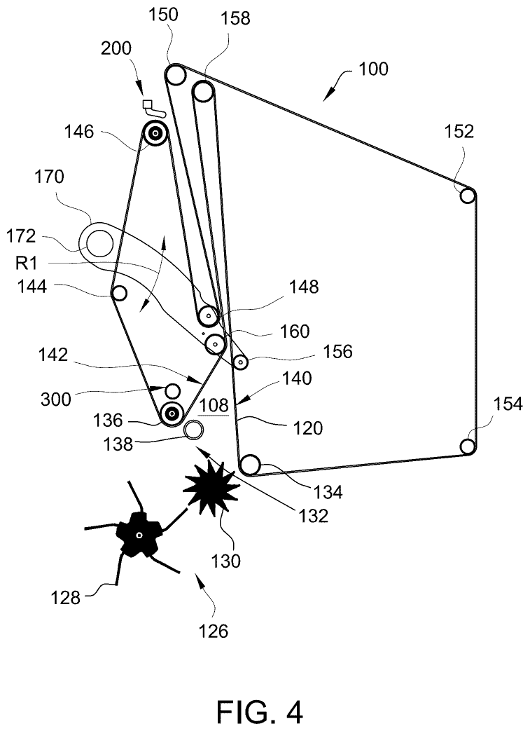

FIGS. 1-4 show various views of a round baler 100 (hereafter, “baler 100”). Specifically, FIG. 1 is a rear perspective view of baler 100, FIG. 2, is a front perspective view of baler 100, FIG. 3 is a front perspective cross-sectional view of baler 100 taken along line 3-3 of FIG. 2, and FIG. 4 is a schematic view of internal components of baler 100 configured to form the crop bale 10 (see, FIGS. 11-13). As discussed herein, baler 100 is configured to form and then eject bales formed from loose forage or crop material picked up by the baler 100.

Additionally, and as discussed herein, baler 100 is configured to form round bales. Bales 10 can be formed from a variety of different material and can be a variety of different sizes. For example, forage or cut crop material can be formed into bales 10 by baler 100. Crop/forage material can include, but is not limited to, straw, hay, grasses, oats, corn stalks, and the like suitable for baling. Further, depending on the type of bale 10 to be formed, the crop/forage material can be baled either after drying or when the crop/forage material is still damp with moisture.

Baler 100 can be towed behind a vehicle (e.g., a tractor)(not shown) via wheels 102 and a hitch mount 104 positioned at a forward end 106 of baler 100. In some examples, baler 100 can be operated as a standalone (e.g., self-propelled) machine.

In one example, the baler 100 uses a baling chamber 108 generally located at a rearward end 110 of baler 100. Baling chamber 108 is defined by and/or included within a fixed front frame portion 112 formed adjacent forward end 106, and a rear lift gate or tailgate portion 118 (hereafter, “tailgate 118”), pivotally coupled to front frame portion 112, adjacent rearward end 110. Baling chamber 108 operates by utilizing at least one bale forming belt 120 routed around a plurality of rollers, as discussed herein. As material is deposited into baling chamber 108, the material is compressed by the tensioned bale forming belts 120. Once a full bale is formed, the bale is ejected from the baling chamber 108 via a tailgate 118 at the rearward end 110. Further details relating to a baling operation within a baling chamber can be found in U.S. Pat. Nos. 7,181,900 and 7,395,756, which are both incorporated herein by reference for all relevant and consistent purposes

Baler 100 includes a mechanical power input 122 (e.g., a PTO shaft) for powering certain components of baler 100. The mechanical power input 122 can be powered by a tow vehicle, such as a tractor. Baler 100 can also include a hydraulic power input 124 that is configured to be powered by the tow vehicle. The tow vehicle is configured to provide pressurized fluid flow via the hydraulic power input 124 to operate certain components of baler 100.

Baler 100 also includes an infeed assembly 126. Generally, first material is picked up by the infeed assembly 126 at the forward end 106 of baler 100. Material is then transferred into baling chamber 108 where a bale is formed. Once a bale is formed, baler 100 temporarily stops and the bale is ejected from the baling chamber 108.

The infeed assembly 126 includes a pick-up device 128 that is configured to rotate about a pick-up device axis A as baler 100 is moving. In some examples, pick-up device 128 can include a plurality of tines that are configured to aid in picking up the loose material from a ground surface. Additionally, infeed assembly 126 includes a feeder device 130 (see, FIGS. 3 and 4) positioned between pick-up device 128 and baling chamber 108. Feeder device 130 is configured to move crop or loose material from pick-up device 128 into baling chamber 108 to interact with bale forming belts 120 to form a bale, as discussed herein. Further details relating to pick-up device 128 and/or feeder device 130 can be found in U.S. Pat. Nos. 6,948,300 and 7,204,074, which are both incorporated herein by reference for all relevant and consistent purposes. In the depicted example, loose material is transferred into the baling chamber 108 via the infeed assembly 126 in a generally upward direction.

Turning to FIGS. 3 and 4, pick-up device 128 and feeder device 130 of infeed assembly 126 moves the crop material through a crop inlet throat 132 to a variable sized bale forming chamber 108 within front frame portion 112 and tailgate 118. Bales are formed within bale chamber 108. The bale chamber 108 is defined by bale forming belts 120, and one or more rollers, such as upper throat roller 138. In this arrangement, the bale forming belts 120 are routed around a plurality of rollers that may include a plurality of idler rollers, drive rollers, and belt tightener rollers. The various rollers may be arranged such that the starting bale forming chamber includes a rear vertical belt span 140 and a front belt span 142. For example, belts 120 are routed around, and follow a travel path, from first drive roller 136, idler roller 144, second drive roller 146, belt tightener roller 148, idler roller 150, idler roller 152, idler roller 154, lower idler roller 134, belt tightener roller 156, idler roller 158, and belt tightener roller 160. Each of the plurality of drive rollers 136, 146 and rollers 134, 144, 150, 152, 154, 158 extend between opposing sidewalls of baler 100. For example, rollers 134, 152, 154 substantially extend and/or are disposed between opposing sidewalls 162, 164 of tailgate 118 of baler 100, while drive rollers 136, 146, and roller 144 substantially extend and/or are disposed between opposing sidewalls 166, 168 of front frame portion 112 of baler 100. Additionally, upper throat roller 138 substantially extends and/or is disposed between opposing front frame sidewalls 166, 168, adjacent first drive roller 136. Belt tightener rollers 148, 156, 160 substantially extend and/or are disposed between opposing frame members of belt tightener 170, as discussed herein.

During operation, and as discussed herein, the incoming crop material is propelled backwards by feeder device 130 into bale forming chamber 108, where the crop material contacts belts 120. The lower roller 134 is rotating clockwise and the rear vertical belt span 140 is moving upwards. The crop material is propelled upwards, by the rear belt span 140, towards the front belt span 142, and is forced to change direction at a belt convergence point, where the two belt spans are close to one another. The crop material starts rolling in a circular manner to form a bale core at this point, and will follow the front belt span 142 down, and into contact with the upper throat roller 138 that is turning clockwise and that will thus propel the crop material back the rear vertical belt span 140 to continue this circular movement.

A belt tightener 170 is coupled to baler 100 and substantially disposed within front frame portion 112. More specifically, belt tightener 170 is rotatably coupled to front frame portion 112, via a pivot 172 that extend between a sidewalls 166, 168 of front frame portion 112 of baler 100. As discussed herein, belt tightener 170 is configured to rotate in a direction (R1) during operation of baler 100 to ensure belts 120 envelop the circumference of and stay in contact with the bale 10 as the bale increases in size and/or diameter. For example, belt tightener 170 and rollers 148, 156, and 160 coupled to belt tightener 170, rotate counterclockwise as bale 10 is formed within bale chamber 108 (see, FIG. 11-13).

As shown in FIGS. 1 and 2, drive rollers 136, 146 are rotated by, for example, a drive system 174 disposed within the front frame portion 112. There are many known configurations for drive system 174. For example, drive system 174 is coupled to and may drive each drive rollers 136, 146 by sprockets 176, 178. Sprockets 176, 178 are driven by chains 180, 182, respectively, which are both coupled to sprocket 184 mounted to, and driven by, drive shaft 186. Drive shaft 186 is connected to mechanical power input 122, that transfers power from a towing vehicle, to rotate drive shaft 186, and move each component of drive system 174, as discussed herein.

To control belt slack during operation, for example after the ejection of bale 10 from baler 100, baler 100 also includes a biasing assembly 190 coupled to the front frame portion 112. The biasing assembly 190 is configured to contact the plurality of belts 120 against one of the plurality of rollers (e.g., idler, drive, or belt tightener rollers).

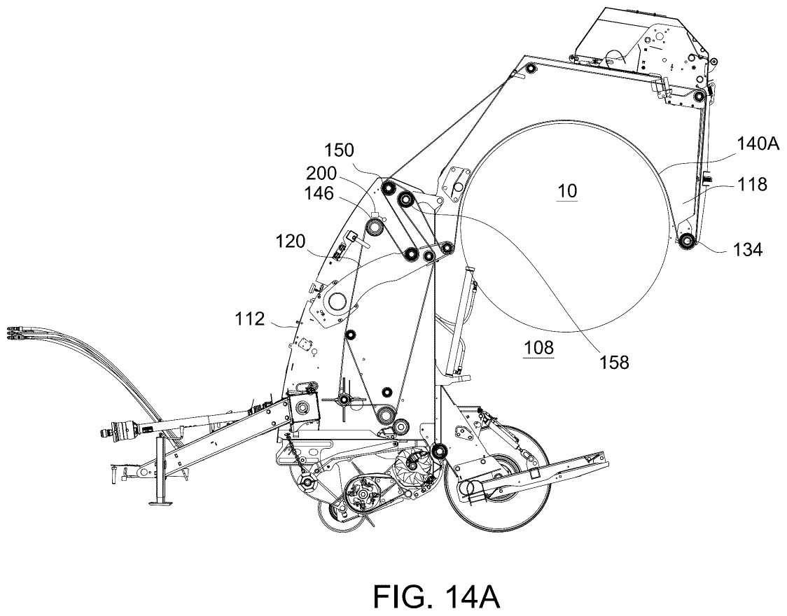

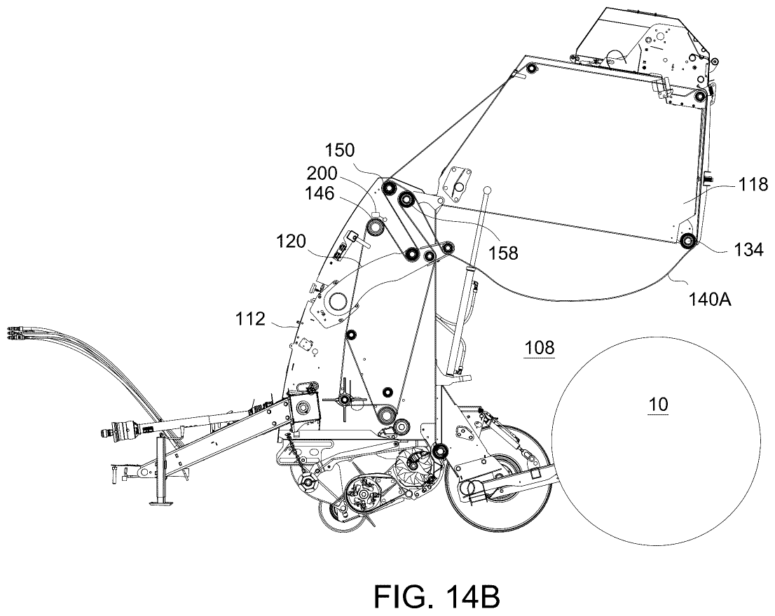

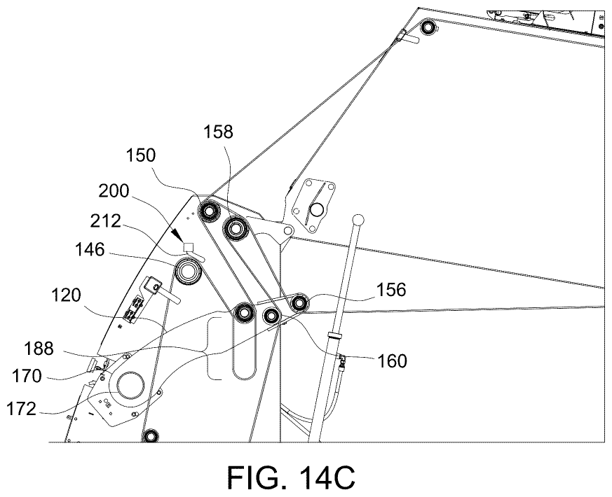

In the illustrated embodiment, the biasing assembly 190 is formed as push arm assembly 200. As shown in FIGS. 2 and 3, push arm assembly 200 is positioned within front frame portion 112 of baler 100. Push arm assembly 200 also extends between opposing sidewalls 166, 168 of front frame portion 112 of baler 100, adjacent to and/or substantially above second drive roller 146. Additionally in the non-limiting example, push arm assembly 200 is positioned adjacent to and/or below rollers 150, 158, respectively. As discussed herein, during operation of baler 100, a component of push arm assembly 200 applies a force to each of the plurality of belts 120 extending through baler 100 to create a belt friction against second drive roller 146. In instances of operation where tension on belts 120 is low and/or zero (e.g., during bale 10 ejection) the force applied to belts 120 by push arm assembly 200 ensure belt slack is in a desirable location-for example, between second driver roller 146 and roller 148 (see e.g., FIG. 14—belt droop 188).

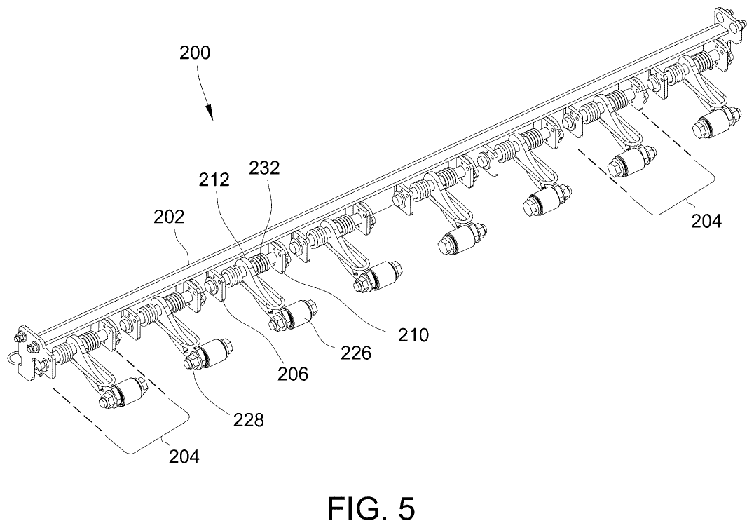

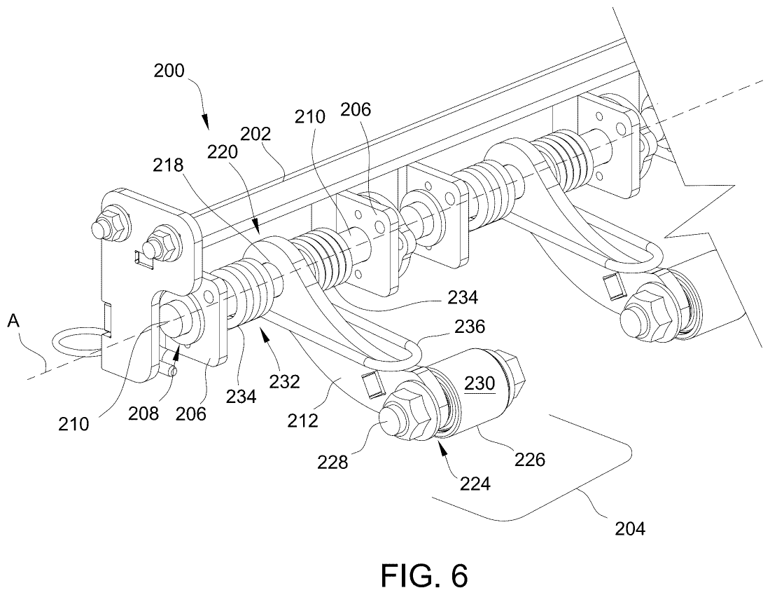

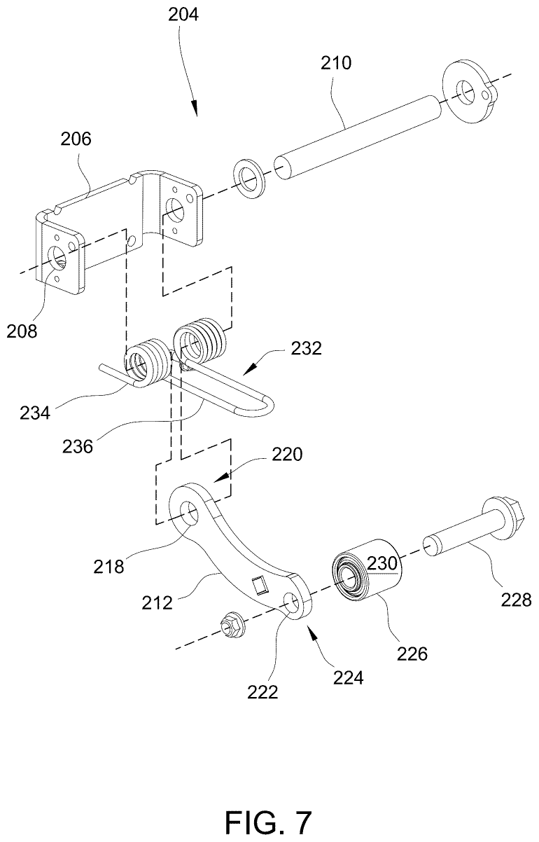

Turning to FIGS. 5-7, a non-limiting example of push arm assembly 200 is shown. More specifically, FIG. 5 shows a perspective view of push arm assembly 200, FIG. 6 shows an enlarged, perspective view of a portion of push arm assembly 200, and FIG. 7 shows an exploded view of a portion of push arm assembly 200.

As shown in FIG. 5, as well as FIG. 2, push arm assembly 200 includes a mounting crossbar 202 that extends between and/or is coupled to opposing sidewalls 166, 168 of front frame portion 112 for baler 100. Crossbar 202 is also positioned adjacent to second drive roller 146. Crossbar 202 is formed from any suitable material configured to support additional components of push arm assembly 200 and position push arm assembly 200 within baler 100, including, but not limited to, metal, metal alloys, polymers, ceramics, and the like.

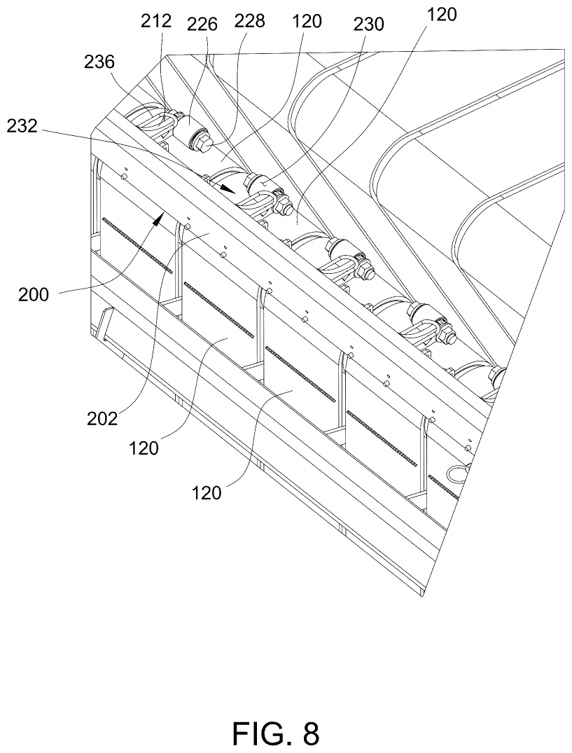

A plurality of arm sub-assemblies 204 are coupled to crossbar 202 of push arm assembly 200. In the non-limiting example shown in FIG. 5, push arm assembly 200 includes eight (8) arm sub-assemblies 204. Each arm sub-assembly 204 corresponds to a single belt of the plurality of belts 120 included in baler 100 (see, FIGS. 1 and 8). As such, the number of arm sub-assemblies 204 is dependent upon, at least in part, the number of belts 120 included in baler 100.

Each of the plurality of arm sub-assemblies 204 includes a mounting bracket 206 coupled to crossbar 202. In non-limiting examples, bracket 206 is releasably coupled, slidably coupled, and/or affixed directly to crossbar 202 of push arm assembly 200. Mounting bracket 206 includes apertures 208 (see, FIGS. 6 and 7) formed therethrough and configured to receiving a first coupling component, such as shaft 210. The first coupling component includes any suitable component or element(s) configured to couple components of each arm sub-assembly 204 to mounting bracket 206. As shown, first coupling component shaft 210 is formed as a pin extending through aperture 208 in mounting bracket 206. Shaft 210 is rotatably mounting within apertures 208. Shaft 210 may be secured within the bracket 206 by washers welded to shaft 210, alternatively, removable fasteners may be used, such as cotter pins, roll pins, or the like. An alternative to shaft 210 and washers may be a threaded fastener, such as a bolt-and-nut combination, where the bolt extends through apertures 208 formed in bracket 206 and is rotatably secured within bracket 206 with one or more threaded fasteners, i.e., nuts. However, the first coupling component can include, but is not limited to, a screw, a cotter pin and bolt, threaded inserts, and the like.

An arm 212 is coupled to and extends from first shaft 210 in each of the plurality of arm sub-assemblies 204 for push arm assembly 200. Arm 212 may be welded to shaft 210. In non-limiting examples shown in FIGS. 6 and 7, arm 212 for each arm sub-assembly 204 includes a first hole 218 formed through a first end 220 that receives shaft 210. That is, first shaft 210 passes through first hole 218 of arm 212 to couple arm 212 to shaft 210 and in turn mounting bracket 206, in push arm assembly 200. Arm 212 also includes a second hole 222 formed through a second end 224, opposite first end 220. As discussed herein, second hole 222 is configured to receive a coupling component configured to couple a press wheel to arm 212. In alternative configurations, arm 212 is configured to rotate or pivot about first shaft 210.

Arm 212 is configured to apply a force to a corresponding belt 120 during operation of baler 100. Although shown as including a curvature and/or swept body extending between first end 220 and second end 224, it is understood that arm 212 can include any shape and/or configuration in order to apply a force to belt 120 of baler 100, as discussed herein. Arm 212 is also formed from any suitable, rigid material including, but not limited to, metal, metal alloys, polymers, ceramics, and the like.

In the non-limiting example shown in FIGS. 5-7, each of the plurality of arm sub-assemblies 204 also include a press wheel 226 rotatably coupled to arm 212 via a second coupling component 228. Each press wheel 226 includes a contact portion or surface 230 that is configured to contact and/or apply a force directly to belt 120 of baler 100 and rotate in response to movement of belt 120, as discussed herein. For example, press wheel 226 is configured to rotate about a second coupling component and/or rotate relative to arm 212 in each of the plurality of arm sub-assemblies 204. Press wheel 226 is formed from any suitable material or assembly that is capable of applying a force to belt 120 and/or creating friction between belt 120 and second drive roller 146 during operation of baler 100. For example, press wheel 226 is formed as any suitable bearing assembly including, but not limited to, a ball bearing, roller bearing, or a bushing formed from a material including, but not limited to, metal, polymers, ceramics, wood, and the like.

Press wheel 226 is coupled to arm 212 via second coupling component 228. For example, and as shown in FIGS. 5-7, second coupling component 228 extends through second hole 222 formed in second end 224 of arm 212, and press wheel 226 is disposed on and/or coupled to coupling component 228. Coupling component 228 includes any suitable component or element(s) configured to couple press wheel 226 to arm 212 at second end 224. As shown, coupling component 228 is formed as a bolt-and-nut combination, where the bolt passes through second hole 222, and press wheel 226 is disposed over the bolt. However, second coupling component 228 can include, but is not limited to, a screw, a pin with fasteners, threaded inserts, and the like. Alternatively, a component 228 may be a pin or shaft mechanically coupled and/or affixed (e.g., welded) to second end 224 of arm 212 for each of the plurality of arm sub-assemblies 204.

Each of the plurality of arm sub-assemblies 204 also include a biasing element, such as a biasing element 232 (e.g., spring). As shown in FIGS. 6 and 7 where biasing element 232 is formed as a spring, biasing element 232 included in the plurality of arm sub-assemblies 204 includes coil portions 234 and an extension portion 236. Coil portions 234 are coupled directly to shaft 210. More specifically, shaft 210 extends through coil portions 234 of biasing element 232, such that coil portions 234 are substantially disposed around shaft 210, adjacent bracket 206. Additionally in the non-limiting example, coil portions 234 are disposed or positioned on either side of first end 220 of arm 212.

Extension portion 236 of biasing element 232 is formed integral to and extends between each coil portion 234. Additionally as shown in FIGS. 5-7, extension portion 236 extends from adjacent first end 220 of arm 212 toward second end 224 of arm 212. During operation of baler 100, biasing element 232 is configured to apply a force on arm 212 such that press wheel 226 of each of the plurality of arm sub-assemblies 204 maintains contact with and/or applies a desired force to the corresponding belt 120. Furthermore, biasing element 232 also configured to allow arm 212 to move and/or pivot about an axis (A) (see, FIG. 6) extending through the center of shaft 210, while also maintaining the contact between belt 120 and press wheel 226, as discussed herein. Although shown and discussed herein as a spring, it is understood that biasing element 232 can be formed as any suitable element or component that is configured to apply a force on arm 212, as discussed herein.

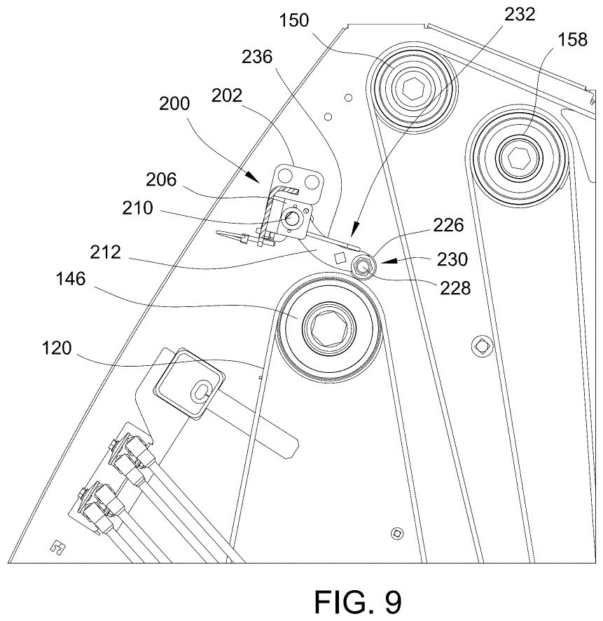

FIGS. 8 and 9 show various views of a portion of baler 100 including push arm assembly 200. More specifically, FIG. 8 shows a front perspective view of a portion of baler 100 including push arm assembly 200, and FIG. 9 shows a cross-sectional side view of a portion of baler 100 including push arm assembly 200. It is understood that similarly numbered and/or named components may function in a substantially similar fashion. Redundant explanation of these components has been omitted for clarity.

In the non-limiting example shown in FIGS. 8 and 9, arm 212 of each of the plurality of arm sub-assemblies 204 forming push arm assembly 200 extend rearward within front frame portion 112, and/or extend toward rollers 150, 158. Additionally, and as discussed herein, each one of the plurality of arm sub-assemblies 204 corresponds to one of the plurality of belts 120 included within baler 100. As such, a single press wheel 226 of each of the plurality of arm sub-assemblies 204 for push arm assembly 200 contacts and applies a force to a corresponding belt 120 of baler 100. The force applied by press wheel 226 of push arm assembly 200 pinches belt 120 against second drive roller 146. In a non-limiting example where second drive roller 146 is formed from a material including a high friction coefficient (e.g., rubber coated roller), the force applied by press wheel 226 of each arm sub-assembly 204 ensures belt 120 is pressed against and/or contacts second drive roller 146 to maintain a desired amount of friction between belt 120 and drive roller 146 during operation.

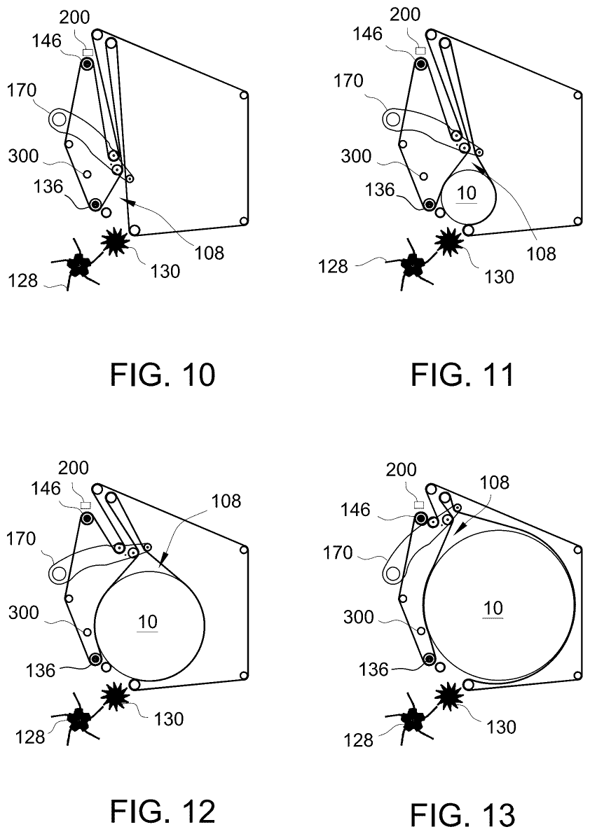

FIGS. 10-13 illustrate an aspect of this arrangement that occurs as bale 10 grows in size. FIG. 10 illustrates baler 100 at the start of bale formation. FIGS. 11-13 illustrate the growing bale 10 and the bale size change as more crop material is added within baling chamber 108.

During the formation of bale 10, bale 10 increases in size and/or diameter. As a result, belt tightener 170, and rollers 148, 156, 160 attached therein, are rotated counterclockwise (upward), toward second drive roller 146, and rollers 150, 158, respectively. Belt tightener 170 rotates about pivot 172 to shorten the length of belt 120 between rollers 148, 150 and second drive roller 146. In doing so, the length of belt 120 defining rear vertical belt span 140 and front belt span 142 (see, FIG. 4) increase to compensate for the increased size of bale 10. Additionally these belt spans 140, 142 take a rounded shape as they follow the outer contour of bale 10. To prevent bale 10 from undesirably moving forward or toward forward end 106 of baling chamber 108, baler 100 also includes a hold-off roller 300 included therein. In the non-limiting examples shown in FIGS. 10-13, as well as FIGS. 3 and 4, hold-off roller 300 is disposed or positioned within front frame portion 112 adjacent to and/or above first drive roller 136. Hold-off roller 300 extends between opposing sidewalls 166, 168 of front frame portion 112.

Prior to bale 10 reaching a certain size or diameter, hold-off roller 300 does not contact any of the plurality of belts 120 within baler 100. However, once bale 10 reaches a given size (e.g., FIG. 13), a portion of belt 120 (e.g., front belt span 142) contacts hold-off roller 300, as shown, for example, in FIG. 13. Additionally, and based on the position of hold-off roller 300 within front frame portion 112, bale 10 formed therein may be prevented from moving closer to forward end 106 and/or limit forward movement of bale 10 formed within baling chamber 108. In turn, any continued growth of bale 10 may push rear vertical belt span 140 of belts 120 toward rearward end 110 because of hold-off roller 300, and in turn move bale 10 rearward during formation. Moreover, positioning hold-off roller 300 adjacent to and above first drive roller 136 reduces the force applied to first drive roller 136 by bale 10, as bale 10 gets larger in size. The inclusion of hold-off roller 300 within baler 100 also improves the discharge of bale 10 once it reaches a desired size, prevents or reduces the likelihood of bale 10 getting stuck within baler chamber 108, and more specifically, stuck within front frame portion 112 of baler 100, thereby preventing or reducing the risk of belts 120 from rubbing and damaging the net wrap applied to bale 10 prior to discharge from baler 100.

Once bale 10 reaches sufficient size (e.g., FIG. 13), tailgate 118 of baler 100 opens to discharge bale 10. FIGS. 14A-14C show cross-sectional views of baler 100 after tailgate 118 is lifted or pivoted from front frame portion 112. Specifically, FIG. 14A is a cross-sectional side view of baler 100 after tailgate 118 is lifted but prior to bale 10 being discharged from baling chamber 108, and FIG. 14B is a cross-sectional side view of baler 100 after bale 10 is discharged from baling chamber 108, and FIG. 14C is an enlarged cross-sectional side view of a portion of baler 100 after bale 10 is discharged from baling chamber 108.

Subsequent to bale 10 being discharged or released from baler 100, and prior to belt tightener 170 rotating clockwise toward first drive roller 136, belts 120 are under low or no tension. That is, during a period of time when belt tightener 170 has not rotated downward (e.g., clockwise), belts 120 are under low or no tension after discharging bale 10 (see, FIG. 14B). Low or no tension in belts 120 may result in belt slack or belt droop. Belt slack occurs during bale 10 ejection, and more specifically when tailgate 118 is raised and the portion of bale 10 in tailgate 118 creates a belt span length of 140A (see, FIG. 14A) starting at rollers 156, around a portion of the circumference of bale 10 and ending at roller 134. Belt span length 140 is the length of the belt span from roller 156 to roller 134, which is generally a straight path, when no bale is in the tailgate (e.g., bale 10 has been ejected) (see, FIG. 4). Belt span length 140A shown in FIG. 14A is longer than belt span length 140 (see, FIG. 4) due the portion of the bale 10 in tailgate 118. The period of time where belts 120 are in a low or no tension condition may occur as the bale 10 ejects from tailgate 118 and before the belt tightener 170 has rotated downward (clockwise) to re-tension the belts 120, as shown in FIG. 14B. Additionally as shown in FIG. 14B, belt span 140A moves or falls (e.g., due to gravity) out of tailgate 118 and toward ejected bale 10, as a result of bale 10 being ejected from tailgate 118. The rotational movement of belt tightener 170 to re-tension belts 120 may be delay/not immediate due to various conditions including, but not limited to, belt tightener 170 contacting bale 10 during ejection, overcoming forces due to hydraulic resistance, and/or belt forces.

During this period of low or no tension, push arm assembly 200 of baler 100 provides a force to press the belts 120 against drive roller 146 creating sufficient friction between the drive roller 146 and belts 120. As a result, drive roller 146, which continues to be driven or rotate during bale 10 ejection, pulls and/or directs belt slack created during bale discharge (e.g., belt span 140; FIG. 14B) to a desirable location. As shown in FIG. 14C, and as discussed herein, belt slack loop 188 is generated and/or defined within baler 100 until belt tightener 170 rotates downward (e.g., clockwise) thereby tightening belts 120. That is, press wheel 226 of each arm sub-assembly 204 for push arm assembly 200 applies a force to a corresponding belt 120 and presses belt 120 into second drive roller 146. As a result, belt slack 188 for belts 120 is formed in the portion of the belt path that extends from the second drive roller 146 to roller 148 included on belt tightener 170.

Allowing second drive roller 146 and push arm assembly 200 to position belt slack 188 in a desired location (L) shown in FIG. 14C substantially prevents or eliminates belt 120 damage and allows belt tightener 170 to tension belts 120 more efficiently (e.g., rotate clockwise faster). Belt tightener 170 can rotate faster because the weight of belt tightener 170 is not needed to pull belt slack 188 from tailgate 118 to roller 148. Push arm assembly 200 also helps pull bale 10 from tailgate 118 as push arm assembly 200 keeps some tension on belts 120 as tailgate 118 is opened. Additionally, the inclusion of push arm assembly 200 within baler 100 to creating friction between the drive roller 146 and belts 120 expediates and/or increases the speed in which belt span 140A reverts back to the tensioned, straight path (see, FIG. 4), prior to the forming of another bale 10 within baler 100.

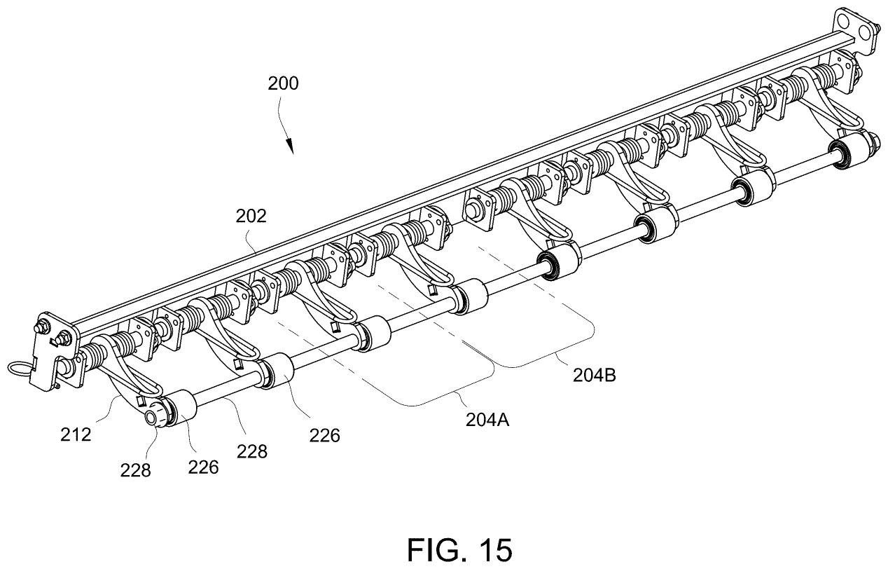

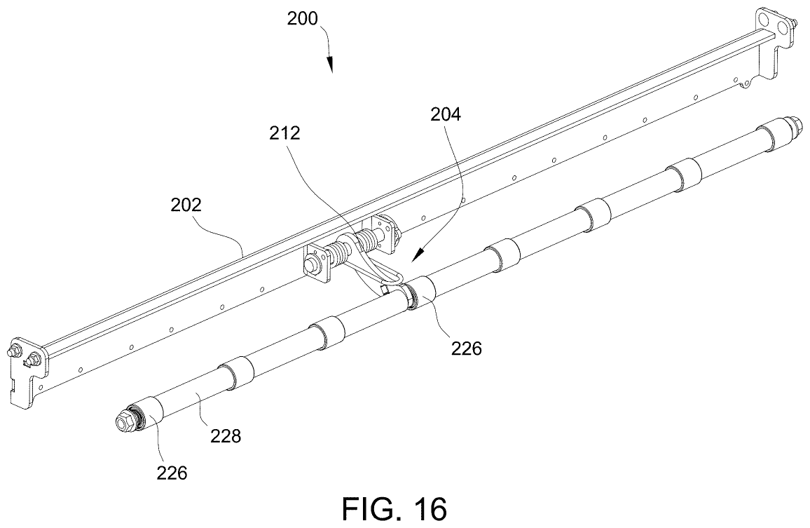

FIGS. 15-19 show various non-limiting examples of push arm assembly 200. Push arm assembly 200 shown in FIGS. 15-19 may be included in baler 100, as similarly discussed herein with respect to FIGS. 1-14. It is understood that similarly numbered and/or named components may function in a substantially similar fashion. Redundant explanation of these components has been omitted for clarity.

FIG. 15 illustrates a perspective view of push arm assembly 200 including a single second coupling component 228. In the non-limiting example, single second coupling component 228 extends between each of the plurality of arm sub-assemblies 204. More specifically, single, second coupling component 228 extends through each second hole 222 formed in arm 212 and corresponding press wheel 226 for each of the plurality of arm sub-assemblies 204 in order to couple press wheel 226 to each arm 212 of push arm assembly 200. Each press wheel 226 included in each of the plurality of arm sub-assemblies 204A, 204B contacts belts 120 of baler 100 during operation, as similarly discussed herein.

FIG. 16 shows another non-limiting example of push arm assembly 200. The inclusion of single second coupling component 228 facilitates fewer arms 212 within push arm assembly 200, and thereby fewer sub assemblies 204. For example, push arm assembly 200 shown in FIG. 16 includes a single, centralized arm 212 to bias the second coupling component 228, and in turn the plurality of press wheels 226 attached thereto, into each of the plurality of belt(s) 120. Although single arm 212 is shown in FIG. 16, it is understood that push arm assembly 200 can include more arms 212 coupled to single, second coupling component 228. For example (not shown), push arm assembly 200 can include two (2) arm sub-assemblies 204 each including arm 212 that extending from and are positioned opposite one another on crossbar 202. In another example (not shown) push arm assembly 200 can include three (3) arm sub-assemblies 204—two (2) end arm sub-assemblies 204 and one (1) centralized arm sub-assembly 204 positioned between the two end arm sub-assemblies 204.

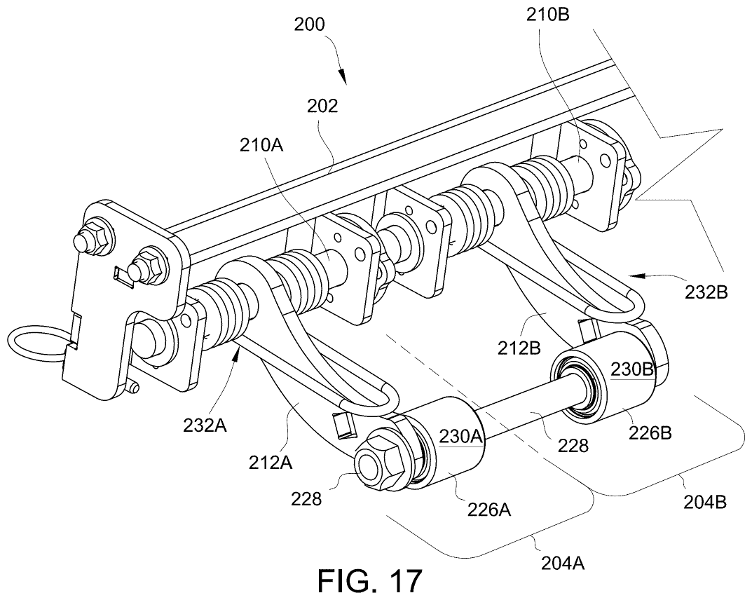

In the non-limiting example shown in FIG. 17, two adjacent arm sub-assemblies 204A, 204B of push arm assembly 200 can share a second coupling component 228. That is, and from the example shown and discussed herein with respect to FIGS. 5-7, push arm assembly 200 shown in FIG. 17 includes a single, second coupling component 228 that is coupled to two arms 212A, 212B for two adjacent arm sub-assemblies 204A, 204B. In the non-limiting example, press wheels 226A, 226B corresponding to and/or included in each arm sub-assembly 204A, 204B is also coupled to and/or disposed over single, second coupling component 228. In the non-limiting example, each press wheel 226A, 226B corresponding to and/or included in the two, adjacent arm sub-assemblies 204A, 204B contacts two and adjacent belts 120 of baler 100 during operation.

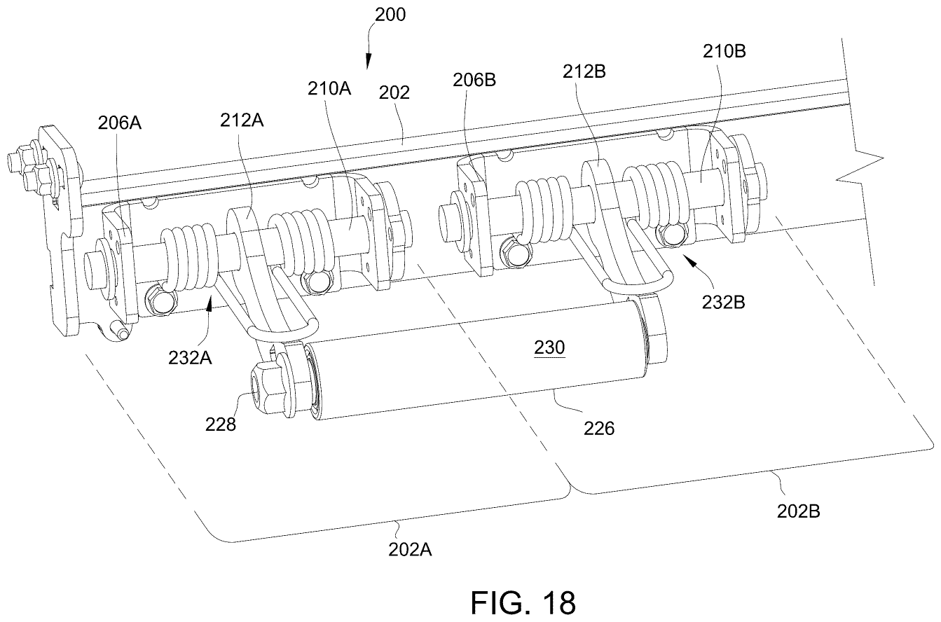

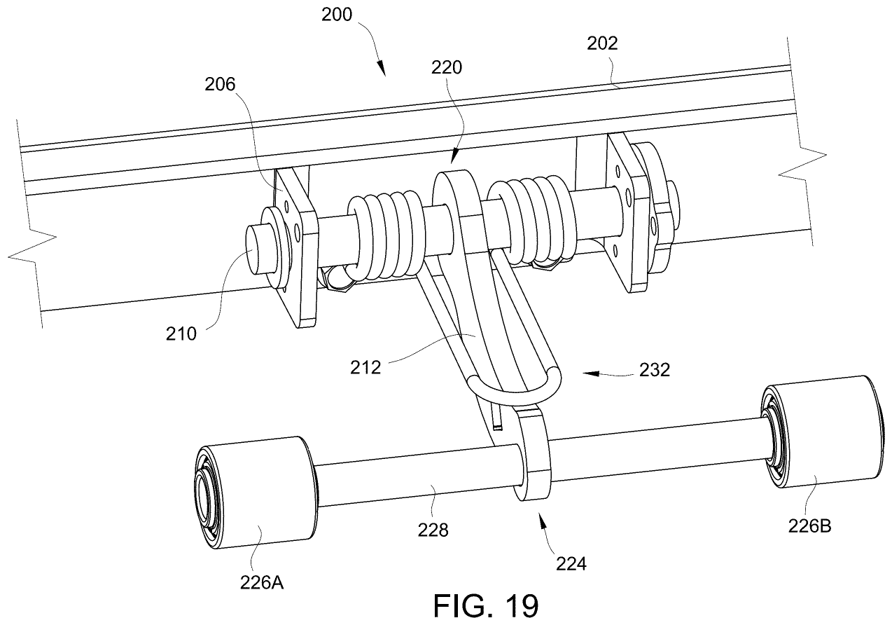

FIG. 18 illustrates a non-limiting example of push arm assembly 200 including two adjacent arm sub-assemblies 204A, 204B of push arm assembly 200 sharing a single, second coupling component 228 and single press wheel 226. More specifically, push arm assembly 200 includes a single, second coupling component 228 that is coupled to two arms 212A, 212B for two adjacent arm sub-assemblies 204A, 204B. Additionally, a single press wheel 226 is coupled to the single, second coupling component 228, and extends between arms 212A, 212B for the adjacent arm sub-assemblies 204A, 204B. In the non-limiting example, single press wheel 226 corresponding to and/or included in the two, adjacent arm sub-assemblies 204A, 204B contacts two and adjacent belts 120 of baler 100 during operation.

FIG. 19 illustrates another non-limiting example of push arm assembly 200 including a single arm sub-assemblies 204 including a single, second coupling component 228, and two press wheels 226A, 226B. More specifically, push arm assembly 200 includes a single, second coupling component 228 that is coupled to a single arm 212, and two press wheels 226A, 226B each coupled to the single, second coupling component 228, opposite one another. In the non-limiting example, each of the two press wheels 226A, 226B coupled to single second coupling component 228, and in turn single arm 212, correspond to and/or contact two adjacent belts 120 of baler 100 during operation. In this non-limiting example, push arm assembly 200 can include less (e.g., half) the number of arm sub-assemblies 204 within baler 100.

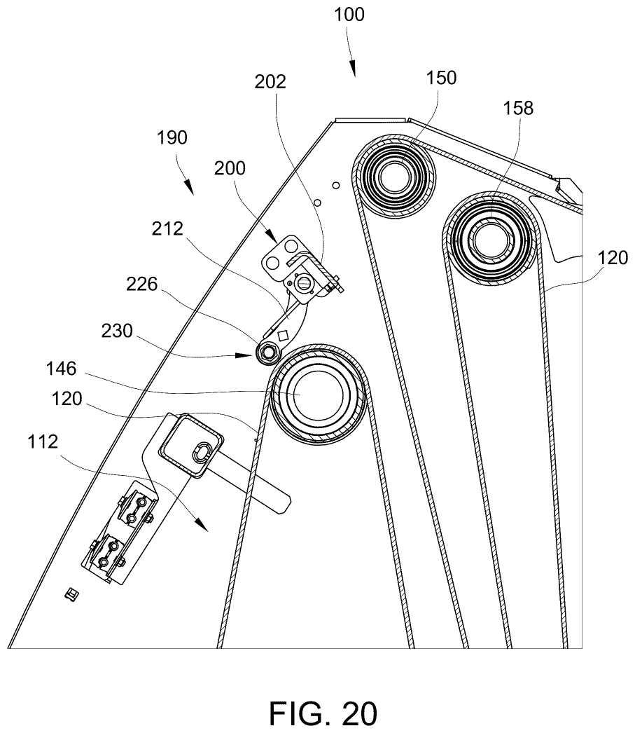

FIG. 20 shows another orientation of push arm assembly 200 within baler 100. For example, and distinct from non-limiting examples discussed herein with respect to FIGS. 8 and 9, the plurality of arm sub-assemblies 204 of push arm assembly 200 can extend forward and/or toward forward end 106. More specifically, each arm 212 included in each of the plurality of arm sub-assemblies 204 for push arm assembly 200 extends toward forward end 106, and contacts each corresponding belt 120 opposite roller 150, 158.

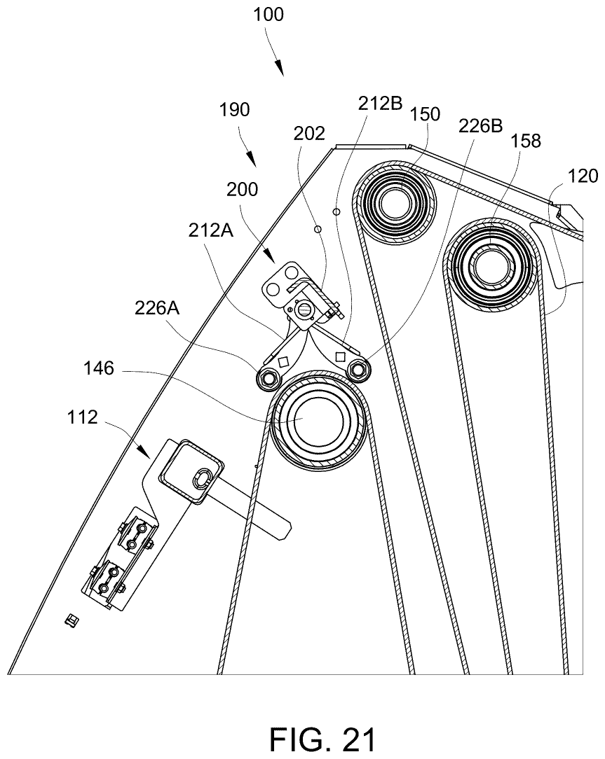

In the non-limiting example shown in FIG. 21, each of the plurality of arm sub-assemblies 204A, 204B of push arm assembly 200 alternate between extending rearward and forward. That is, two adjacent arm sub-assemblies 204A, 204B extend in distinct directions within baling chamber 108. For example, a first arm 212A for first arm sub-assembly 204A extends forward or toward forward end 106 of baler 100, while second arm 212B for adjacent, second arm sub-assembly 204B extends rearward or toward rearward end 110 of baler 100.

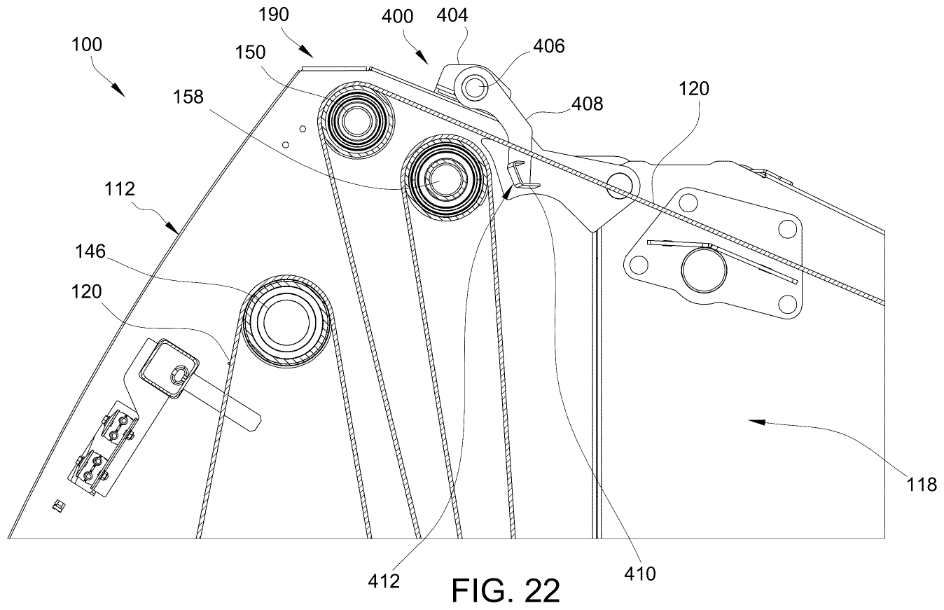

Briefly returning to FIG. 1, and with reference to FIGS. 22-25, an additional feature for controlling belt slack within baler 100 is shown. More specifically, baler 100 includes a biasing assembly 190 formed as brake assembly 400 coupled to front frame portion 112, mounted to opposing sidewalls 166, 168, and adjacent belts 120, respectively. Brake assembly 400 discussed herein may be used in conjunction with or alternatively may replace push arm assembly 200 for controlling belt slack 488 within baler 100 during operation.

Brake assembly 400 of baler 100 includes opposing hydraulic presses or actuators 402 (hereafter, “actuators 402”) coupled to portions of baler 100. More specifically, each actuator 402 of brake assembly 400 is coupled to an opposing sidewall 166, 168 of front frame portion 112 for baler 100. In non-limiting examples, actuator 402 is coupled to and/or in communication with hydraulic power input 124 configured to lift tailgate 118. As such, the same hydraulic input that controls the movement of tailgate 118 is also used to actuate actuators 402 of brake assembly 400, as discussed herein. In another non-limiting example, actuators 402 of brake assembly 400 is controlled by an independent valve system (not shown) to selectively actuate a brake arm during the operation of baler 100. As discussed herein, the actuation of actuators 402 displace, move, and/or rotate components or portions of brake assembly 400 to apply a brake arm to belts 120 of baler 100 for controlling belt slack.

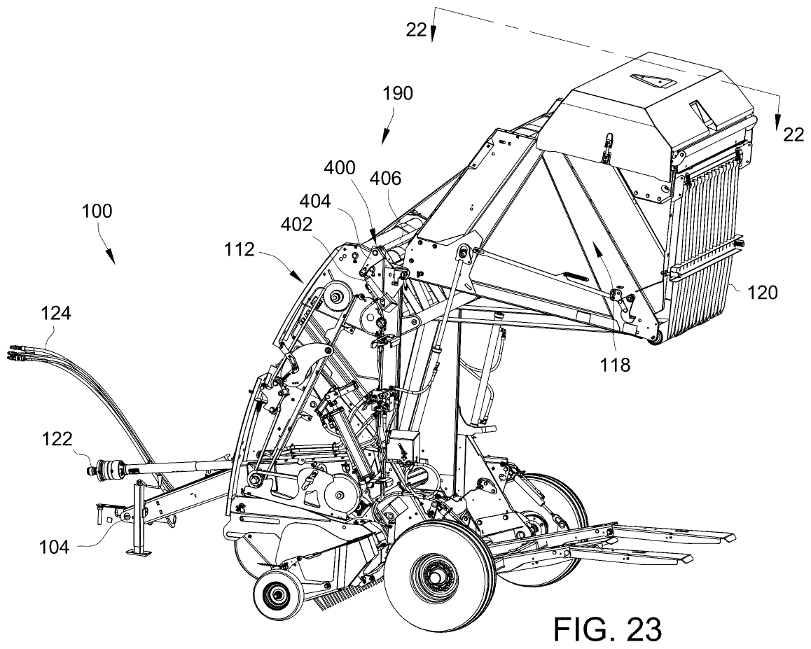

As shown in FIGS. 1 and 23, brake assembly 400 also includes two coupling plates 404 and a cross beam 406 extending therebetween. Each coupling plates 404 is coupled or affixed to actuator 402 disposed on opposing sidewalls 166, 168 of front frame portion 112. Coupling plates 404 extend upward from actuators 402, such that a portion of two coupling plates 404 are positioned above front frame portion 112 and/or the plurality of belts 120 extending therein. Cross beam 406 extends between and is coupled to each two coupling plate 404 of brake assembly 400 to provide support to the brake arms of brake assembly 400, as discussed herein. Additionally as discussed herein, cross beam 406 is pivotally mounted to the front frame portion 112 and forms a pivot point for brake arms of brake assembly 400 during operation.

Turning to FIG. 22, and with continued reference to FIGS. 1 and 23, brake assembly 400 also includes brake arms 408 coupled to cross beam 406, respectively. In the non-limiting example, brake arms 408 extend downward from coupling plate 404 and/or cross beam 406 and into front frame portion 112 of baler 100. Additionally as shown in FIG. 22, brake arms 408 include a brake bar 410 having a contact surface 412 that is positioned within front frame portion 112, adjacent to roller 158. During operation of baler 100, actuators 402 are activated to adjust the position of brake arms 408 and brake bar 410 between a first position and a second position. For example, when tailgate 118 of baler 100 opens, actuators 402 are activated to extend and when tailgate 118 closes actuators 402 will retract, resulting in brake arms 408 and brake bar 410 from moving between distinct positions. In the first position, such as during bale 100 formation or empty bale chamber 108, brake arms 408/brake bar 410 are positioned (e.g., pivoted about 406) such that brake bar 410 does not contact belt 120 moving over roller 158. As shown in FIG. 22 when brake arms 408 and brake bar 410 are in the first position, brake bar 410 is spaced apart from belts 120 and/or roller 158.

In the second position, such as when tailgate 118 is opened during bale 10 ejection (e.g., FIGS. 23-25), brake arms 408 and/or brake bar 410 are moved or rotated about cross beam 406 based on the activation of actuators 402 of brake assembly 400. In the second position, brake bar 410 is position directly adjacent to roller 158, such that contact surface 412 contacts belt 120. Additionally in the second position, brake bar 410 applies a force and/or squeezes belts 120 against roller 158 to create friction to stop and/or hold belts 120 from moving during bale 10 ejection.

The round baler may include a controller that regulates the position of the brake arms 408 and/or brake bar 410. For example, the controller may be configured to move the brake bar 410 to the second position when the tailgate 118 is in an open position.

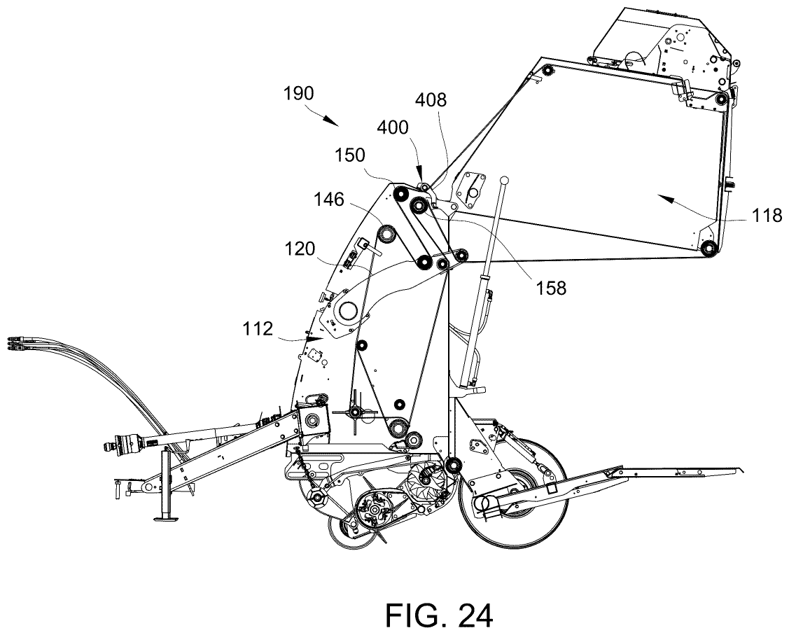

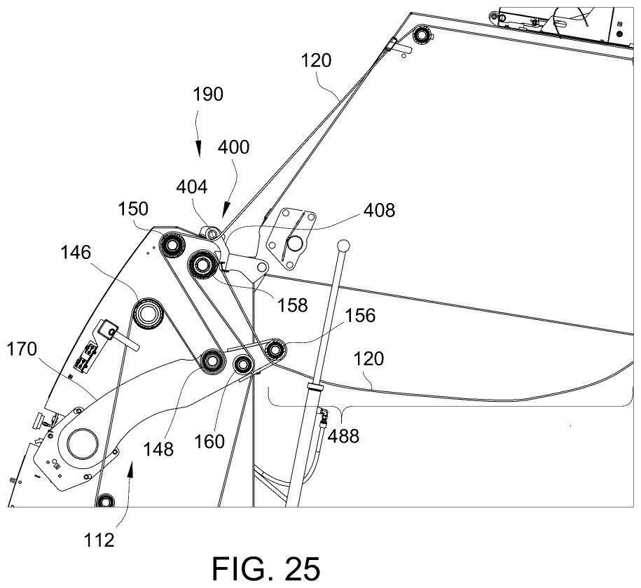

In the non-limiting example shown in FIGS. 24 and 25, brake arms 408 and brake bar 410 are actuated to be in the second position, such that brake bar 410 contacts belt 120 and/or presses belts 120 against roller 158. As a result of brake bar 410 contacting belts 120 adjacent roller 158, belt slack 488 is defined and/or generated downstream in the movement path of belts 120 from roller 158, and/or roller 156. Additionally as shown in FIGS. 24 and 25, a portion of belt 120 contacts cross beam 406 of brake assembly 400 when tailgate 118 is lifted and bale 10 is ejected.

Brake bar 410 contacting belt 120 and subsequently pinching belt 120 against roller 158 controls, retains belt slack 488 to a desirable location, such as between rollers 156 and 134, until belt tightener 170 tightens belts 120. That is, and as discussed herein. Allowing brake assembly 400 to position belt slack 188 in the location shown in FIGS. 24 and 25 substantially prevents or eliminates belt 120 damage. Moreover, brake assembly 400 helps control belt slack 188 during bale discharge by pressing belts 120 against roller 158 which effectively creates enough friction to substantially prevent drive rollers 136, 146 from pulling and/or driving belts 120 and/or prevent belt slack 488 to be undesirably pulled to first drive roller 136. Belt slack 488 is contained, for example, to tailgate region and/or within tailgate 118, where bale 10 is formed and subsequently ejected from.

Although roller 158 is illustrated and described herein as the component of baler 100 in which brake assembly 400 utilizes to press belts 120 against, other configurations and/or components may be used by brake assembly 400. For example (not shown) brake assembly 400 can be positioned adjacent and be configured to press belts 120 against a stationary crossmember positioned along the belt 120 within baler 100. In the exemplary embodiment, the stationary crossmember can be positioned adjacent roller 158 in order to ensure belt slack 488 is formed and/or controlled within baler 100 during operation, as similarly discussed herein.

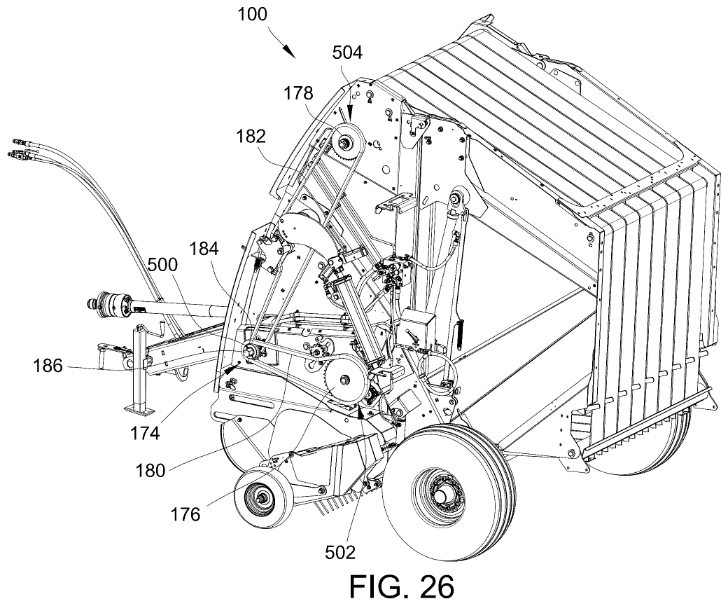

Turning to FIG. 26, baler 100 shown includes at least one clutch to selectively control the operation of drive rollers 136, 146 during operation. In a non-limiting example, baler 100 includes clutch 500 at sprocket 184 and/or drive shaft 186. More specifically, clutch 500 is coupled to and/or in communication with sprocket 184 and/or drive shaft 186 of drive system 174 to selectively engage or disengage drive system 174 of baler 100. Clutch 500 is formed from any suitable electrical or mechanical clutch that is configured to control the engagement of drive shaft 186 of drive system 174 during operation. Engaging drive shaft 186 via clutch 500 ensures first drive roller 136 and second drive roller 146 are driven and/or rotated as discussed herein. Additionally, disengaging drive shaft 186 via clutch 500 in communication with sprocket 184/drive shaft 186 may also disengage or cease the driving or rotation of both first drive roller 136 and second drive roller 146 coupled to drive shaft 186 via sprockets 176, 178 and chains 180, 182, as discussed herein. In the non-limiting example where clutch 500 is coupled to and/or in communication with drive shaft 186, disengaging drive shaft 186 results in the disengagement of first drive roller 136 and second drive roller 146 simultaneously and/or at the same time.

In non-limiting examples, drive roller 136, 146 are disengaged when tailgate 118 is opened during bale 10 ejection (see, FIG. 23). Clutch 500 is engaged or disengaged at certain points of tailgate 118 movement. For example, clutch 500 is configured (e.g., mechanical clutch) or programmed (e.g., electric clutch) to disengage drive rollers 136, 146 just before bale 10 is ejected (e.g., when tailgate 118 begins to lift), and then reengage drive rollers 136, 146 when belt tightener 170 has had an opportunity to re-tension belts 120. The reengaging of drive rollers 136, 146 via clutch 500 can occur, for example, before tailgate 118 is fully closed to prevent any belt slack 188 from being pinched when tailgate 118 is fully closed. The effect of disengaging drive roller 136, 146 with clutch 500 is to stop belts 120, such that belt slack 188 stays in a desirable location (e.g., within tailgate 118 (see, FIG. 25)). When drive rollers 136, 146 are disengaged via clutch 500, there is little motivation for belt slack 188 to move to first drive roller 136 and/or if belt slack 188 occurs in an undesirable area (e.g., adjacent first drive roller 136), belt tightener 170 can tension belts 120 before clutch 500 reengages drive rollers 136, 146.

In another non-limiting example, baler 100 can include a single clutch 502 at sprocket 176. More specifically, clutch 502 is coupled to and/or in communication with sprocket 176 and first drive roller 136 to selectively engage or disengage first drive roller 136. Engaging first drive roller 136 via clutch 502 ensures first drive roller 136 is driven and/or rotated as discussed herein. Additionally, disengaging first drive roller 136 via clutch 502 in communication with sprocket 176/first drive roller 136 may disengage or cease the driving or rotation of first drive roller 136. In the non-limiting example where clutch 502 is only coupled to and/or in communication with first drive roller 136 and/or sprocket 176, disengaging first drive roller 136 does not result in the disengagement of second drive roller 146 during operation.

In further example, clutch 504 is coupled to and/or in communication with sprocket 178. That is, and as shown in FIG. 26, clutch 504 is coupled to and/or in communication with sprocket 178 and second drive roller 146 to selectively engage or disengage second drive roller 146. Engaging second drive roller 146 via clutch 504 ensures second drive roller 146 is driven and/or rotated during the operation of baler 100. Moreover, disengaging first drive roller 136 via clutch 504 in communication with sprocket 178/second drive roller 146 disengages or ceases the drive or rotation of second drive roller 146. In the non-limiting example where baler 100 only includes clutch 504, disengaging second drive roller 146 does not result in the disengagement of first drive roller 136 during operation.

In still further example, baler 100 includes both clutch 502, as well as clutch 504. As similarly discussed herein, clutches 502, 504 selectively engage and disengage each of first drive roller 136 and second drive roller 146, respectively. In the non-limiting example where baler 100 includes both clutch 502 and clutch 504, each drive roller 136, 146 can be disengage/engage at distinct times. For example, and during operation of baler 100, second drive roller 146 can be disengaged prior to first drive roller 136 and/or tailgate 118 is being lifted. Subsequent to disengaging second drive roller 146, and as well as lifting tailgate 118 in its entirety, first drive roller 136 can be disengaged via clutch 504 to ensure belt slack 188 is in a desired position (e.g., downstream in path of belt 120 movement from first drive roller 136).

This written description uses examples to disclose the invention, including the best mode and to enable a person of ordinary skill in the relevant art to make and practice the invention, including making and using any devices or systems and performing any incorporated methods. The patentable scope of the invention is defined by the claims. Such other examples are within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

What is claimed is:

1. A round baler comprising:
a front frame portion;
a tailgate pivotally coupled to the front frame portion;
a drive system disposed within the front frame portion;
a drive roller coupled to the drive system, the drive system configured to drive the drive roller;
a belt tightener rotatably coupled to the front frame portion, the belt tightener including a belt tightener roller;
a plurality of belts for forming a bale chamber;
a plurality of rollers that contact the plurality of belts, the plurality of rollers including the drive roller, the belt tightener roller, and a plurality of idler rollers; and
a biasing assembly coupled to the front frame portion, the biasing assembly configured to contact the plurality of belts and press the plurality of belts against one of the plurality of rollers.

2. The round baler of claim 1, wherein the biasing assembly is configured to press the plurality of belts against the drive roller, the biasing assembly comprising a push arm assembly.

3. The round baler of claim 1, wherein the biasing assembly is configured to press the plurality of belts against one of the plurality of idler rollers, the biasing assembly comprising a brake assembly.

4. The round baler of claim 1, wherein the biasing assembly includes:
a crossbar extending between and coupled to two opposing sidewalls of the front frame portion, the crossbar positioned adjacent to one of the drive roller; and
a plurality of arm sub-assemblies coupled to the crossbar, each of the plurality of arm sub-assemblies including:
an arm extending from and pivotally mounted to the crossbar, the arm including a first end and a second end opposite the first end; and
a press wheel coupled to the second end of the arm, the press wheel rotatably coupled to the arm.

5. The round baler of claim 4, wherein the press wheel of each of the plurality of arm sub-assemblies is positioned directly adjacent the drive roller and maintains contact with a corresponding belt of the plurality of belts.

6. The round baler of claim 4, wherein each of the plurality of arm sub-assemblies further includes:
a bracket coupled to the crossbar, the first end of the arm pivotally coupled to the bracket;
a first coupling component coupling the arm to the bracket;
a biasing element coupled to the first coupling component and positioned adjacent the arm, the biasing element configured to bias the press wheel against the belt; and
a second coupling component coupling the press wheel to the arm.

7. The round baler of claim 4, wherein the arm of each of the plurality of arm sub-assemblies extends rearward toward the tailgate.

8. The round baler of claim 4, wherein the arm of each of the plurality of arm sub-assemblies extends forward toward a forward end of the front frame portion, opposite the tailgate.

9. The round baler of claim 1, wherein the biasing assembly includes:
an actuator positioned on a sidewall of the front frame portion;
a cross beam pivotally attached to the front frame and extending between the sidewall and an opposite sidewall of the front frame portion;
an actuator arm attached to the cross beam and the actuator; and
a brake arm attached to the cross beam, the brake arm including a brake bar extending between the sidewalls of the front frame portion, wherein the brake bar is positioned adjacent to one of the plurality of idler rollers.

10. The round baler of claim 9, wherein the actuator is configured to actuate each brake arm and the brake bar between a first position and a second position.

11. The round baler of claim 10, wherein in the first position the brake bar is separated from the plurality of belts, and in the second position the brake bar maintains contact with the plurality of belts and presses the plurality of belts into the one of the plurality of idler rollers.

12. The round baler of claim 11, wherein the round baler comprises a controller that is configured to move the brake bar to the second position when the tailgate is in an open position.

13. A method of controlling belt slack in a round baler during bale discharge, the round baler comprising a front frame portion; a tailgate pivotally coupled to the front frame portion; a drive roller; a belt tightener including a belt tightener roller; a plurality of belts for forming a bale chamber; a plurality of rollers that contact the plurality of belts, the plurality of rollers including the drive roller, the belt tightener roller, and a plurality of idler rollers; and a biasing assembly coupled to the front frame portion, the method comprising:
forming a bale in the bale chamber of the round baler;
raising the tailgate and discharging the bale from the round baler;
driving the drive roller during bale formation and bale discharge;
wherein the biasing assembly contacts the plurality of belts and presses the plurality of belts against one of the plurality of rollers while the tailgate is raised.

14. The method of claim 13, wherein the biasing assembly presses the plurality of belts against the drive roller, the biasing assembly comprising:
a crossbar extending between and coupled to two opposing sidewalls of the front frame portion, the crossbar positioned adjacent to the drive roller; and
a plurality of arm sub-assemblies coupled to the crossbar, each of the plurality of arm sub-assemblies including:
an arm extending from and pivotally mounted to the crossbar, the arm including a first end and a second end opposite the first end; and
a press wheel coupled to the second end of the arm, the press wheel rotatably coupled to the arm.

15. The method of claim 14, wherein pressing the plurality of belts against the drive roller comprises maintaining contact between the press wheel of each of the plurality of arm sub-assemblies and a corresponding belt of the plurality of belts.

16. The method of claim 15, wherein each arm sub-assembly comprises a biasing element and a coupling component positioned adjacent the arm, the biasing assembly being coupled to the first coupling component, the biasing element pressing the press wheel of each of the plurality of arm sub-assemblies toward the corresponding belt and the drive roller.

17. The method of claim 15, wherein pressing the plurality of belts against the drive roller comprises pinching each of the plurality of belts between the drive roller and the corresponding press wheel.

18. The method of claim 14, wherein the biasing assembly presses the plurality of belts against one of the plurality of idler rollers, the biasing assembly including a brake assembly comprising:
an actuator positioned on a sidewall of the front frame portion;
a cross beam pivotally attached to the front frame and extending between the sidewall and an opposing sidewall of the front frame portion;
an actuator arm attached to the cross beam and the actuator; and
a brake arm attached to the cross beam, the brake arm including a brake bar extending between the opposing sidewalls of the front frame portion, wherein the brake bar is positioned adjacent to one of the plurality of idler rollers.

19. The method of claim 18, wherein pressing the plurality of belts against one of the plurality of idler rollers comprises maintaining contact between the brake bar and the plurality of belts and between the plurality of belts and the one of the plurality of idler rollers.

20. The method of claim 19, further comprising activating the actuator of the brake assembly to actuate each brake arm and the brake bar between a first position and a second position, wherein in the first position the brake bar is separated from the plurality of belts, and in the second position the brake bar maintains contact with the plurality of belts.
